(19) United States
(12) Patent Application Publication
(10) Pub. No.: US 2026/0027721 A1
(43) Pub. Date: Jan. 29, 2026

(54) METHOD FOR AUTOMATED DOCKING OF TWO PARTS COMPRISING SERVO-CONTROL WITH PROFILOMETERS

(71) Applicant: INSTITUT DE RECHERCHE TECHNOLOGIQUE JULES VERNE, Bouguenais (FR)

(72) Inventors: Gilles CHABERT, Carquefou (FR); Adolfo SUAREZ ROOS, Paris (FR)

(73) Assignee: INSTITUT DE RECHERCHE TECHNOLOGIQUE JULES VERNE, Bouguenais (FR)

(21) Appl. No.: 18/994,261

(22) PCT Filed: Jul. 16, 2023
(86) PCT No.: PCT/EP2023/069739

§ 371 Date: Jan. 14, 2025

(30) Foreign Application Priority Data
Jul. 16, 2022 (FR) FR2207294

(51) Int. Cl. B25J 9/16; B64F 1/22; G01B 11/30

(52) U.S. Cl. CPC B25J 9/1687; B25J 9/1607; B64F 1/22; G01B 11/303

(57) ABSTRACT

The invention relates to a method for automated docking of a stationary part (1) with a movable part (2) capable of being moved towards the stationary part by a robot (3), the stationary part (1) and the movable part (2) each comprising an end (4, 5), the two ends forming a docking interface (6). The method comprises the steps of positioning of multiple profilometers around the docking interface so that the docking interface is located in the field of view of the profilometers, determination of a target profile of the end of the movable part, measurement of a profile of the end of the movable part by the profilometers, comparison of the target profile and the measured profile, generating a speed setpoint in the measurement space, and movement of the movable part towards the stationary part (1) by the robot (3) on the basis of this speed setpoint.

### TECHNICAL FIELD OF THE INVENTION

The invention relates generally to the technical field of automated methods for docking two parts, and more particularly to the precision docking of metal sheets by robotic systems. It also covers aa docking device implementing these methods.

The invention relates more specifically to an automated docking method for aligning two aircraft fuselage parts prior to a riveting operation, for example.

This type of robotic system is also known as a machine tool. The term “machine tool” refers to a mechanical system made up of servo-controlled digital axes. These may include robotic gantries or industrial robots, hereinafter referred to as robots.

### STATE OF THE ART

In general, the structure of an aircraft is very complex, and is often divided into several structural elements with large cross-sections. For example, the fuselage of an aircraft is made up of several metal or composite sheets that are joined together. To be assembled, these sheets are first precisely positioned in relation to one another, then pressed together.

Aircraft manufacturers currently use a global positioning of fuselage sections, using a laser-tracking metrology system. Docking is then carried out iteratively by the operators, who alternate between reading the relative positions of the sections to be assembled and moving the support holding one of the sections. For certain types of aircraft, the alignments of sheet metal at interfaces are not guaranteed by tolerancing. Misalignments or collisions are frequent and considerably disrupt adjustment, necessitating corrective maneuvers or fitting operations. In addition, manual fitting requires the operator's experience to compensate for tool deformation, alignment errors and mechanical play. This manual moving method is also very time-consuming.

Document CN110919654, which aims to solve these problems, discloses a camera-controlled robotic arm. The camera produces images of the interface between two parts of an aircraft fuselage to be assembled, which are transmitted to an image processing system, which in turn calculates a movement setpoint that is transmitted to the robotic arm.

However, prior art camera control systems are not precise and can lead to collisions or friction between sheets.

### DISCLOSURE OF THE INVENTION

The invention aims to remedy all or part of the drawbacks of the state of the art by proposing in particular an automated docking method that is more precise than the prior art.

The invention focuses solely on local interface matching and can be coupled with a global section positioning process if required.

According to a first aspect of the invention, a method is proposed for automated docking of a stationary part with a movable part capable of being moved towards the stationary part by a robot. The stationary part and the movable part each comprise an end. The two ends form a docking interface.

The docking method comprises the steps of:
positioning of multiple profilometers around the docking interface so that the docking interface is located in the field of view of the profilometers, the profilometers being fixed relative to the stationary part,
determining a target profile of the end of the movable part,
measuring a profile of the end of the movable part by the profilometers,
comparing the target profile and the measured profile, generating a movement setpoint based on a deviation between the target profile and the measured profile, and
moving the movable part towards the stationary part by the robot on the basis of the movement setpoint.

According to a variant, during the step of measuring a profile of the end of the movable part, each profilometer carries out a measurement at a point of the end of the movable part, generating a measurement vector (x, z, α), with (x, z) designating the coordinates of a point A of the profile at the end of the movable part and a the tangent to the profile at point A, x being a coordinate in a scanning direction of the profilometer, approximately parallel to the direction of advance of the movable part, and z being a coordinate in a transverse direction perpendicular to the scanning direction.

According to another variant, target vectors (x′, z′, α′) are generated when determining a target profile of the end of the movable part, with (x′, z′) designating the coordinates of a target point A′ of a target profile and a′ the tangent to the target point A′, x′ being a coordinate in the scanning direction parallel to the direction of advance of the movable part and z′ being a coordinate in the transverse direction.

According to another variant, the measurement vectors (x, z, α) are compared with the target vectors (x′, z′, α′) to determine a deviation between the target and the observed movable part. From their deviation, a velocity vector in sensor space is determined, with the norm set to follow a particular profile of bounded acceleration. The direction of the velocity vector is also determined. A pseudo-inverse operation of the interaction matrix is applied to this velocity vector to obtain Cartesian velocities, and a multiplication by the robot's inverse Jacobian matrix is applied to the Cartesian velocities to obtain a movement setpoint.

According to another variant, the docking method comprises an initialization step wherein the position of the stationary part relative to the profilometers is determined so that three target vectors can be generated, including a first target vector (x′, z′, α′) for a presentation step of the parts, a second target vector (x′, z′, α′) for an overlapping step of the parts, and a third target vector (x′, z′, α′) for a for a pressing step of the parts.

According to another variant, the docking method comprises, after the initialization step, three successive servo-control loops of the profiles of the end of the movable part by the profilometers obtained thanks to the approximate position of the movable part relative to the robot and the approximate position of the profilometers and of the stationary part relative to the robot. This makes it possible to generate the desired robot velocities in the measurement space. The uncertainty of these positionings is compensated for by closed-loop control.

According to another variant, the servo-control loops each comprise a profile measurement operation at point A of the end of the movable part by profilometers generating a measurement vector (x, z, α) during the presentation step of the parts, the overlapping step of the parts and the pressing step of the parts.

According to another variant, during the presentation step of the parts, the distances between the two parts, along the scanning direction and the transverse direction, are a few centimeters. During the overlapping step, the movable part translates towards the stationary part in the scanning direction up to a distance of less than a few millimeters in the scanning direction, while maintaining a distance of a few centimeters from the stationary part in the transverse direction. During the pressing step, the movable part translates relative to the stationary part in the transverse direction until the two parts are in contact.

The invention also relates to a device for automated docking of a movable part towards a stationary part using a docking method as defined above.

The docking device comprises:
multiple profilometers distributed at different points of the interface and configured to measure the profile of the end of the movable part and the profile of the end of the stationary part,
processing means configured to generate a movement setpoint for the movable part relative to the stationary part from measurements of the profile of the end of the movable part and the profile of the end of the stationary part taken by the profilometers, and
a robot configured to move the movable part relative to the stationary part according to the movement setpoint.

According to one variant, the profilometers are laser profilometers distributed evenly around the docking interface.

According to another variant, the profilometers are attached to a stationary part of the robot.

The invention thus makes it possible to provide an automated docking method that ensures the correct matching of interfaces, is simpler and more precise than those of the prior art, and reduces the duration of the docking operation to less than 1 minute. This method can be coupled with a global section positioning method, for example, in master/slave mode.

The proposed solution does not create collision or friction between the parts, until they are intentionally brought into contact in the final phase.

The proposed solution ensures optimal docking by providing several contact points for sections of around 4 m in diameter. The contact points are distributed along the interface, without the need to deform the parts. The contact area can be enlarged, at the cost of conformation of the parts.

It also offers positioning repeatability of the order of 0.2 mm right up to the moment when the parts start to be conformed.

Furthermore, profilometers don't require very precise positioning around their respective nominal positions. There's no need to recalibrate.

The solution is generic and can be extended to types of parts and applications other than aircraft.

### BRIEF DESCRIPTION OF THE FIGURES

Other features and advantages of the invention will become apparent on reading the following description, with reference to the appended figures, which show:

FIG. 1: a view of a movable part moving relative to a stationary part during a docking method according to one embodiment of the invention;

FIG. 2: a graph with three vectors, including vectors measured by the profilometers;

FIG. 3: a diagram showing the various stages of the automated docking method used to obtain a movement setpoint.

For greater clarity, identical or similar elements are identified by identical reference signs in all of the Figures.

### DETAILED DESCRIPTION OF ONE EMBODIMENT

The invention relates to a method for automated docking of a stationary part 1 with a movable part 2 capable of being moved towards the stationary part 1 by a robot 3. The stationary part 1 and the movable part 2 each comprise an end 4, 5. The two ends 4, 5 form a docking interface 6.

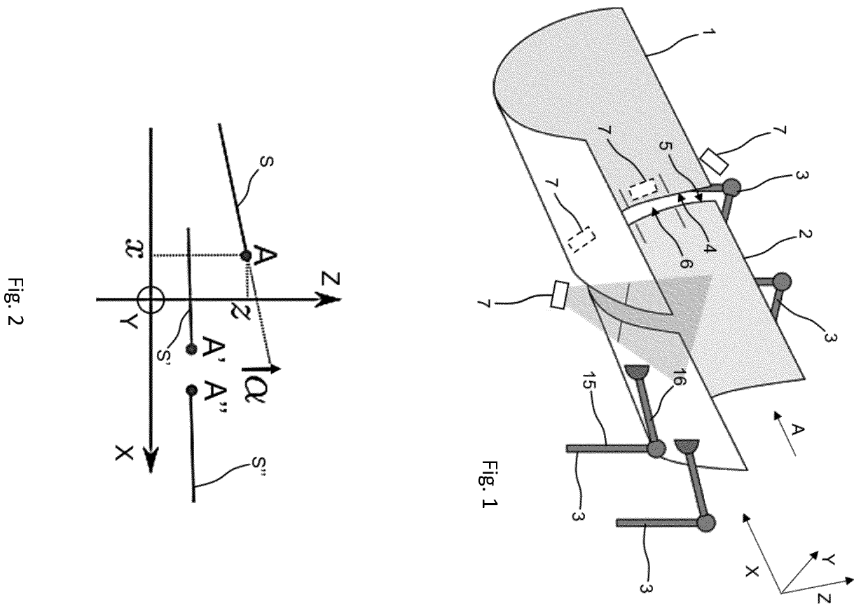

FIG. 1 shows a view of the movable part 2 moving relative to the stationary part 1 during the docking method.

Robot 3 refers to a robotic system, also known as a machine tool. A machine tool can be a mechanical system made up of servo-controlled digital axes. These may include robotic gantries or industrial robots, hereinafter referred to as actuators.

In the following example, the movable part 2 is moved by four robots 3 formed by actuators. Two actuators are positioned on either side of the movable part 2.

Each robot 3 comprises a stationary part 15 attached to the floor, connected to a movable part 16 enabling the movable part 2 to be moved.

In this example, the movable part 2 and the stationary part 1 are curved metal sheets approximately half-spherical in shape. The movable part 2 and the stationary part 1 are portions of an aircraft fuselage. Other shapes and applications are also possible.

According to one possible embodiment of the invention, the docking method comprises a step of positioning multiple profilometers 7 around the docking interface 6 so that the docking interface 6 is located within the field of view of the profilometers 7. The profilometers 7 are stationary in relation to the stationary part 1.

Preferably, at least three profilometers 7 are evenly distributed around the docking interface 6.

The profilometers 7 used can be “ScanControl” profilometers 7 from the Micro-epsilon company, for example.

It is important to distribute the profilometers 7 evenly along the docking interface 6 to be able to benefit from uniform control of the joint between the two parts 1, 2.

On the other hand, in the case of boat-shaped parts 1, 2, the profilometers 7 are located at the end of the parts 1, 2 and are subject to significant flexibility of the parts 1, 2 at this point. Parts 1, 2 are deformed under their own weight. This deformation cannot be compensated for by the docking system, which is limited to rigid displacements only. The conformation is achieved through contact between parts 1, 2 and is not controlled.

Thus, a good compromise is needed. The profilometers 7 must be well spaced out, while remaining located in “controllable” zones of parts 1, 2, that is, rigidly linked as much as possible to the actuators. It should be noted that “bubbles”, which are difficult to model, may form when parts 1, 2 come into contact in areas that are nevertheless rigid. This makes it virtually impossible to choose the ideal location for profilometers 7, which must therefore be done empirically.

According to a preferred embodiment, the docking method comprises three steps, including a presentation or approach step of parts 1, 2. The movable part 2 is “presented” opposite the stationary part 1. The movable part 2 is properly aligned with the stationary part 1. The distances between the two parts 1, 2 along a scanning direction X and a transverse direction Z are a few centimeters.

The scanning direction X of the profilometers 7 is approximately parallel to the direction of advance A of the movable part 2. The transverse direction Z is substantially perpendicular to the scanning direction X and substantially parallel to the laser emission direction of the profilometers 7. There is a direction Y perpendicular to the directions X and Z.

In this example and in relation to FIG. 1, the scanning direction X is substantially parallel to the axis of the parts 1, 2 and the transverse direction Z is substantially orthogonal to their surface.

The docking method also comprises an overlapping step in which the movable part 2 translates towards the stationary part 1 along the scanning direction X up to a distance of less than 4 mm along the scanning direction X and maintaining a distance of a few centimeters relative to the stationary part 1 along the transverse direction Z.

This is followed by a pressing together step wherein the movable part 2 translates relative to the stationary part 1 in the transverse direction Z until the two parts 1, 2 are in actual or imminent contact. For example, the distance in the transverse direction Z may be 2 mm. The parts 1, 2 are then deformed or conformed by applying a force in the transverse direction Z until a threshold is reached, which may be 800 Newton, for example.

The movements of the movable part 2 during these three steps are obtained by a servo-control based on measurements of the profile of the end 5 of the movable part 2 and the profile of the end of the stationary part 1. The information from each profilometer 7 gives a point cloud from which it is possible to extract a straight line, representing the profile of the part observed.

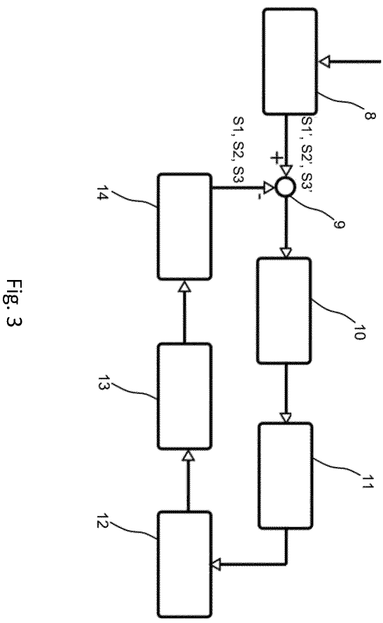

FIG. 2 shows the profile or S vector of the movable part 2, the profile or S″ vector of the stationary part 1 and the profile or S′ vector of the target in the case of a single profilometer 7. With n profilometers 7, vectors S and S′ have 3n components.

The docking method comprises a servo-control loop in which a target profile of the end 5 of the movable part 2 is determined for the three steps previously described, and in which profiles of the end 5 of the movable part 2 and profiles of the end 4 of the stationary part 1 are measured by profilometers 7.

In particular, the docking method comprises an initialization step wherein the position of the stationary part 1 relative to the profilometers 7 is measured, so that three target vectors S1′, S2′, S3′ can be generated, a first target vector S1′ having coordinates (x′₁, z′₁, α′₁) during the presentation step of the parts, a second target vector S2′ with coordinates (x′₂, z′₂, α′₂) during the overlapping step of the parts and a third target vector S3′ with coordinates (x′₃, z′₃, α′₃) during the pressing step of the parts.

The relative position of the stationary part 1 with respect to the actuators, or more precisely with respect to the stationary part 15 of the actuators, is known approximately because the stationary part 1 is referenced in a workshop reference frame.

The relative position of the stationary part of the actuators with respect to the movable part 2 is also known approximately at all times, by the geometry of the stationary part 1 and the actuator model.

Finally, the relative position of the stationary part 1 with respect to the profilometers 7 is also known approximately. Excessively degraded precision can compromise control stability.

The concatenation of the information read from the n profilometers 7 yields a measurement vector of the stationary part 1 S″ with coordinates (x″, z″, α″), where (x″, z″) are the coordinates of a point (A″) of a profile at the end of the stationary part 1 and α″ is the tangent to the point (A″), x″ being a coordinate in the scanning direction (X) and z″ being a coordinate in the transverse direction (Z).

The stationary part measurement vector 1 (x″, z″, α″) obtained with the stationary part 1 enables one degree of freedom to be set very precisely in orientation for the profilometer 7 (rotation about an axis parallel to the transverse direction Y, in the profilometer frame of reference) and two in translation (along the X and Z directions). By rotating the profilometer around an axis parallel to the scanning direction X until the value is minimized along an axis parallel to the transverse direction Z, it is also possible to obtain precise orthogonality, that is, to know the rotation with respect to the scanning direction X. The other degrees of freedom of profilometers 7 remain estimated. In practice, a translation error of the order of a centimeter in the Y direction and a rotation error of the order of 1° in the Z transverse direction do not compromise docking convergence for sheet diameters reaching several meters, as the impact on the setpoint S′ is negligible.

The docking method comprises a step to determine a target profile for the end of the movable part 2.

In the presentation step, a first target vector S1′ with coordinates (x₁′, z₁′, α₁′) is generated, with (x₁′, z₁′) designating the coordinates of a target point (A₁′) of a target profile and α₁′ the tangent to the target point (A₁′), x₁′ being a coordinate in the scanning direction (X) and z₁′ being a coordinate in the transverse direction (Z).

By measuring the profile of the stationary part 1 and the position of the profilometers 7 relative to this part, the first target vector S1′ can be generated.

Each profilometer 7 then observes the movable part 2 and applies processing to obtain a first measurement vector S1. The monitor of each profilometer 7 superimposes the reconstructed profile on the raw profile image, and an operator validation is expected for safety. Visual validation is carried out by checking that the overlap is correct.

The first measurement vector S1 is obtained in a measurement step 14, as shown in the diagram in FIG. 3.

The docking method comprises the initialization step 8 during which the first target vector S1′ is calculated from data relating to the profilometer model 7, the profile of the stationary part 1 and the geometry of the docking interface 6, the positions between the stationary part 1 and the profilometers 7 and the docking requirements, such as, for example, compliance with a distance, which is a few centimeters along the scanning direction X and the transverse direction Z, for the presentation step.

The first measurement vector S1 and the first target vector S1′ are compared in a comparison operation 9 to determine a profile deviation between the target and the observed movable part 2.

The following proportional feedback law is used to calculate a desired velocity \dot{S} in measurement space: \dot{S}=λ(S₁−S′₁), where λ is a positive gain factor. This vector is then normalized to the desired profile (bounded acceleration).

An interaction matrix Ls is then calculated. The interaction matrix is the name usually given to the Jacobian linking the Cartesian kinematic torsor to velocities in measurement space.

A pseudo-inverse operation of the interaction matrix 11 is then applied to this velocity vector to obtain Cartesian velocities v with the law: \dot{S}=L_{s·}v

A multiplication operation by the inverse Jacobian matrix of the robot 3 (or actuators) 12 is applied to the Cartesian velocities to obtain a first movement setpoint comprising a displacement velocity of the robot and in particular a joint velocity.

The actuators move the movable part 2 towards the stationary part 1 as a function of the first movement setpoint in a control step 13.

The step of overlapping parts 1, 2 comprises the same operations as the presentation step. In the overlapping step, a second target vector S2′ with coordinates (x₂′, z₂′, α₂′) is generated, with (x₂′, z₂′) designating the coordinates of a target point (A₂′) of a target profile and α₂′ the tangent to the target point (A₂′), x₂′ being a coordinate in the scanning direction (X) and z₂′ being a coordinate in the transverse direction (Z).

By measuring the profile of the stationary part 1 and the position of the profilometers 7 relative to this part, the second target vector S2′ can be generated.

Then, each profilometer 7 observes the movable part 2 and applies processing to obtain a second measurement vector S2 with coordinates (x₂, z₂, α₂). Validation by the operator is no longer necessary at this stage, as the measurement is carried out by a tracking method.

The second measurement vector S2 is obtained in measurement step 14, as shown in the diagram in FIG. 3.

The docking method comprises the initialization step 8, during which the second target vector S2′ is calculated from data relating to the profilometer model 7, the profile of the stationary part 1 and the geometry of the docking interface 6, the positions between the stationary part 1 and the profilometers 7 and the docking requirements, such as maintaining a distance, for example a few millimeters in the X scanning direction and a few centimeters in the Z transverse direction, for the overlapping step.

The second measurement vector S2 and the second target vector S2′ are compared in comparison operation 9 to determine a profile deviation between the target and the observed movable part 2.

A velocity vector is determined from this deviation, as in the docking method.

The pseudo-inverse operation of the interaction matrix 11 is then applied to the velocity profile to obtain Cartesian velocities.

The operation of multiplying by the inverse Jacobian matrix of robot 3 (or actuators) 12 is applied to the Cartesian velocities to obtain a second movement setpoint and, in particular, a joint velocity.

The actuators move the movable part 2 towards the stationary part 1 as a function of the second movement setpoint in a control step 13.

The step of pressing the parts together also comprises the same operations as the presentation and overlapping steps. In the step of pressing the parts together, a third target vector S3′ with coordinates (x₃′, z₃′, α₃′) is generated, with (x₃′, z₃′) designating the coordinates of a target point (A₃′) of a target profile and α₃′ the tangent to the target point (A₃′), x₃′ being a coordinate in the scanning direction (X) and z₃′ being a coordinate in the transverse direction (Z).

By measuring the profile of the stationary part 1 and the position of the profilometers 7 relative to this part, the third target vector S3′ can be generated.

Then, each profilometer 7 observes the movable part 2 and applies processing to obtain a third measurement vector S3 with coordinates (x₃, z₃, α₃).

The third measurement vector S3 is obtained in measurement step 14, as shown in the diagram in FIG. 3.

The docking method comprises the initialization step 8 during which the third target vector S3′ is calculated from data relating to the profilometer model 7, the profile of the stationary part 1 and the geometry of the docking interface 6, the positions between the stationary part 1 and the profilometers 7 and the docking requirements, such as for example actual contact or a distance of 2 mm between the parts 1, 2 in the transverse direction Z, for the step of pressing the parts together.

The third measurement vector S3 and the third target vector S3′ are compared in comparison operation 9 to determine a profile deviation between the target and the observed movable part 2.

A velocity vector is determined from this deviation in a velocity profile calculation operation 10.

The pseudo-inverse operation of the interaction matrix 11 is then applied to the velocity vector to obtain Cartesian velocities.

The operation of multiplying by the inverse Jacobian matrix of robot 3 (or actuators) 12 is applied to the Cartesian velocities to obtain a third movement setpoint.

The actuators move the movable part 2 towards the stationary part 1 as a function of the third movement setpoint in the control step 13.

These calculations are made possible despite the uncertain position of profilometers 7, but under the assumption that parts 1, 2 must be aligned. The tangent a for the movable part 2 and the tangent α″ for the stationary part 1 are therefore equal.

Calculating the interaction matrix at each instant requires (at least approximate) knowledge of the point A detected in the (X, Z) plane of profilometer 7, and of the plane tangent to movable part 2 at point A, which is made possible by the chain of transformations: position of profilometers 7 relative to stationary part 1, position of stationary part 1 relative to the fixed base of the actuators, and position of the stationary part 15 of the actuators relative to movable part 2.

As previously mentioned, during the presentation, overlapping and pressing steps, the deviation between the target and the movable part 2 generates the direction of a velocity vector. The standard is then calculated so that it follows a velocities profile ensuring smooth, uniform acceleration up to a maximum velocity, as well as uniform deceleration. However, in proximity to the target (distance less than 1 mm), the constraint on deceleration is lifted to avoid making the drive unstable.

The stopping criterion applied to each step is a maximum deviation in the X or Z direction of 1.2 mm. This relatively large value absorbs errors in part geometry, as well as the deformations added to it, which would render the setpoint inconsistent with a smaller criterion. The consequence would be a lack of convergence, with the system oscillating around an unattainable setpoint. Nevertheless, the averaging effect on the n profilometers 7 and the lever arm obtained by their spacing enables a method repeatability much better than the stopping criterion, of the order of 0.2 mm.

Of course, the invention is described in the foregoing by way of example. It is understood that a person skilled in the art is able to produce different variant embodiments of the invention without departing from the scope of the invention.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A method for automated docking of a stationary part with a movable part capable of being moved towards the stationary part by a robot, the stationary part and the movable part each comprising an end, the two end of each of the stationary part and the movable part forming a docking interface, wherein the method comprises the steps of:
positioning multiple profilometers around the docking interface so that the docking interface is located in a field of view of the profilometers, the profilometers being stationary relative to the stationary part,
determining a target profile of the end of the movable part,
measuring a profile of the end of the movable part by the profilometers,
comparing the target profile and the measured profile, generating a movement setpoint based on a deviation between the target profile and the measured profile, and
moving the movable part towards the stationary part by the robot on the basis of the movement setpoint.

2. The docking method according to claim 1, wherein, during the step of measuring a profile of the end of the movable part, each profilometer performs a measurement at a point A of the end of the movable part generating a measurement vector (x, z, α), with (x, z) designating coordinates of a point A of the profile at the end of the movable part and α a tangent to the profile at point A x being a coordinate along a scanning direction of the profilometer, approximately parallel to the direction of advance of the movable part and z being a coordinate along a transverse direction perpendicular to the scanning direction.

3. The docking method according to claim 1, wherein target vectors (x′, z′, α′) are generated when determining a target profile of the end of the movable part, with (x′, z′) designating coordinates of a target point A′ of a target profile and α′ being a tangent to a target point A′, x′ being a coordinate in a scanning direction parallel to a direction of advance of the movable part and z′ being a coordinate in a transverse direction.

4. The docking method according to claim 3, wherein measurement vectors (x, z, α) are compared with the target vectors (x′, z′, α′) to determine a velocity vector in sensor space from their deviation, a pseudo-inverse operation of an interaction matrix being applied to this velocity vector to obtain Cartesian velocities, and a multiplication by an inverse Jacobian matrix of the robot being applied to the Cartesian velocities to obtain a movement setpoint.

5. The docking method according to claim 3, wherein it comprises an initialization step in which the position of the stationary part relative to the profilometers is determined so that three target vectors can be generated, including a first target vector (x′₁, z′₁, α′₁) for a presentation step of the stationary part and the movable part, a second target vector (x′₂, z′₂, α′₂) for an overlapping step of the stationary part and the movable part and a third target vector (x′₃, z′₃, α′₃) for a pressing step of the stationary part and the movable part.

6. The docking method according to claim 5, wherein it further comprises, after the initialization step, three successive servo-control loops of the profiles of the end of the movable part by the profilometers, obtained from an approximate position of the movable part relative to the robot and the approximate position of the profilometers and of the stationary part relative to the robot, making it possible to generate displacement velocities of the robot achieving desired velocities in a measurement space.

7. The docking method according to claim 6, wherein the servo-control loops each comprise a profile measurement operation at the point (A) of the end of the movable part by profilometers generating a measurement vector (x, z, α) during the presentation step of the stationary part and the movable part, the overlapping step of the stationary part and the movable part and the pressing step of the stationary part and the movable part.

8. The docking method according to claim 5, wherein during the presentation step of the stationary part and the movable part, distances between the stationary part and the movable part along a scanning direction and a transverse direction are a few centimeters, during the overlapping step, the movable part translates towards the stationary part in the scanning direction to a distance of less than a few millimeters in the scanning direction, while maintaining a distance of a few centimeters from the stationary part in the transverse direction, during the pressing step, the movable part translates relative to the stationary part in the transverse direction until the stationary part and the movable part are in contact.

9. A device for automated docking of a movable part towards a stationary part implementing a docking method as defined in claim 1, the stationary part and the movable part each comprising one end, the end of each of the stationary part and the movable part forming a docking interface, wherein it comprises:
multiple profilometers distributed at different points of the interface and configured to measure the profile of the end of the movable part and the profile of the end of the stationary part,
processing means configured to generate a movement setpoint for the movable part relative to the stationary part from measurements of the profile of the end of the movable part and the profile of the end of the stationary part performed by the profilometers, and
a robot configured to move the movable part relative to the stationary part according to the movement setpoint.

10. The docking device according to claim 9, wherein the profilometers are laser profilometers evenly distributed around an alignment interface.

11. The docking device according to claim 9, wherein the profilometers are integral with a stationary part of the robot.
